(19) United States
(12) Patent Application Publication
(10) Pub. No.: US 2019/0096073 A1
(43) Pub. Date: Mar. 28, 2019

(54) HISTOGRAM AND ENTROPY-BASED TEXTURE DETECTION

(71) Applicant: Intel Corporation, Santa Clara, CA (US)

(72) Inventor: Jun Nishimura, San Jose, CA (US)

(73) Assignee: Intel Corporation, Santa Clara, CA (US)

(21) Appl. No.: 16/007,500

(22) Filed: Jun. 13, 2018

(51) Int. Cl. G06T 7/44; G06T 1/20

(52) U.S. Cl. CPC G06T 7/44; G06T 15/04; G06T 2207/20081; G06T 1/20

(57) ABSTRACT

A mechanism is described for facilitating histogram and entropy-based texture detection in computing systems, according to one embodiment. A method of embodiments, as described herein, includes detecting an image of a scene, and computing multi-scale local binary pattern (LBP) image for the detected image based on a noise model associated with the detected image. The method may further include calculating a local histogram based the multi-scale LBP image, and calculating LBP entropy based on the local histogram. The method may further include applying a threshold to convert the LBP entropy into textureness of a texture map of the detected image for processing by an image signal processing (ISP) engine.

### FIELD

Embodiments described herein relate generally to data processing and more particularly to facilitate histogram and entropy-based texture detection.

### BACKGROUND

Several conventional techniques attempt to deal with distinguishing texture regions and noise reduction, but such conventional techniques are inherently inefficient and inconsistent for any number of reasons, such as failing to accurately preserve weak textures due to the difficulty in obtaining 256-bin lookup tables to represent a texture map to be processed by image signal processing (ISP) blocks or engines.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a histogram and entropy-based texture detection mechanism according to one embodiment.

FIG. 2 illustrates a histogram and entropy-based texture detection mechanism according to one embodiment.

FIG. 3A illustrates a transactional sequence of a conventional technique.

FIG. 3B illustrates a transactional sequence for texture map calculation based on local binary patterns histogram entropy according to one embodiment.

FIG. 3C illustrates a pipeline incorporating a texture map of FIG. 3B according to one embodiment.

FIG. 4 illustrates a method for facilitating histogram entropy-based texture detection according to one embodiment.

FIG. 5 illustrates a computer device capable of supporting and implementing one or more embodiments according to one embodiment.

FIG. 6 illustrates an embodiment of a computing environment capable of supporting and implementing one or more embodiments according to one embodiment.

### DETAILED DESCRIPTION

In the following description, numerous specific details are set forth. However, embodiments, as described herein, may be practiced without these specific details. In other instances, well-known circuits, structures and techniques have not been shown in detail in order not to obscure the understanding of this description.

Embodiments provide for a novel technique for using noise model-based local binary pattern (LBP) to account for spatially varying noise property and calculating entropy of this noise model based on LBP histogram to convert LBP into textureness. In one embodiment, by applying this novel technique, ISP may be promoted to preserve weak textures accurately which, in turn, improves image quality competitiveness over conventional techniques.

It is contemplated that terms like “request”, “query”, “job”, “work”, “work item”, and “workload” may be referenced interchangeably throughout this document. Similarly, an “application” or “agent” may refer to or include a computer program, a software application, a game, a workstation application, etc., offered through an application programming interface (API), such as a free rendering API, such as Open Graphics Library (OpenGL®), DirectX® 11, DirectX® 12, etc., where “dispatch” may be interchangeably referred to as “work unit” or “draw” and similarly, “application” may be interchangeably referred to as “workflow” or simply “agent”. For example, a workload, such as that of a three-dimensional (3D) game, may include and issue any number and type of “frames” where each frame may represent an image (e.g., sailboat, human face). Further, each frame may include and offer any number and type of work units, where each work unit may represent a part (e.g., mast of sailboat, forehead of human face) of the image (e.g., sailboat, human face) represented by its corresponding frame. However, for the sake of consistency, each item may be referenced by a single term (e.g., “dispatch”, “agent”, etc.) throughout this document.

In some embodiments, terms like “display screen” and “display surface” may be used interchangeably referring to the visible portion of a display device while the rest of the display device may be embedded into a computing device, such as a smartphone, a wearable device, etc. It is contemplated and to be noted that embodiments are not limited to any particular computing device, software application, hardware component, display device, display screen or surface, protocol, standard, etc. For example, embodiments may be applied to and used with any number and type of real-time applications on any number and type of computers, such as desktops, laptops, tablet computers, smartphones, head-mounted displays and other wearable devices, and/or the like. Further, for example, rendering scenarios for efficient performance using this novel technique may range from simple scenarios, such as desktop compositing, to complex scenarios, such as 3D games, augmented reality applications, etc.

It is to be noted that terms or acronyms like convolutional neural network (CNN), CNN, neural network (NN), NN, deep neural network (DNN), DNN, recurrent neural network (RNN), RNN, and/or the like, may be interchangeably referenced throughout this document. Further, terms like “autonomous machine” or simply “machine”, “autonomous vehicle” or simply “vehicle”, “autonomous agent” or simply “agent”, “autonomous device” or “computing device”, “robot”, and/or the like, may be interchangeably referenced throughout this document.

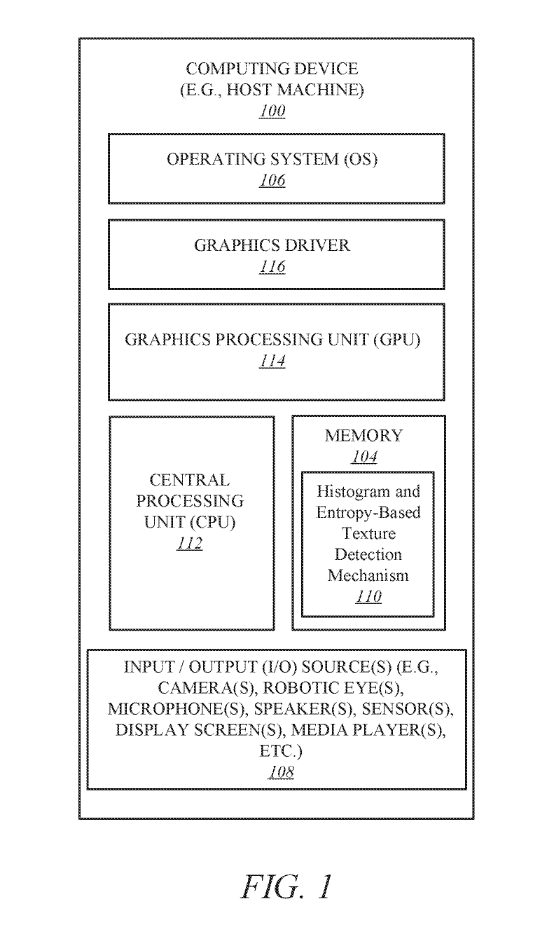

FIG. 1 illustrates a computing device 100 employing a histogram and entropy-based texture detection mechanism (“texture detection mechanism”) 110 according to one embodiment. Computing device 100 represents a communication and data processing device including or representing (without limitations) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet-based cable television set-top boxes, etc.), global positioning system (GPS)-based devices, automotive infotainment devices, etc.

In some embodiments, computing device 100 includes or works with or is embedded in or facilitates any number and type of other smart devices, such as (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SoC” or “SOC”), integrating various hardware and/or software components of computing device 100 on a single chip.

As illustrated, in one embodiment, computing device 100 may include any number and type of hardware and/or software components, such as (without limitation) graphics processing unit (“GPU” or simply “graphics processor”) 114, graphics driver (also referred to as “GPU driver”, “graphics driver logic”, “driver logic”, user-mode driver (UMD), UMD, user-mode driver framework (UMDF), UMDF, or simply “driver”) 116, central processing unit (“CPU” or simply “application processor”) 112, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, “circuitry”, and “mechanism” may include, by way of example, software or hardware and/or a combination thereof, such as firmware.

In one embodiment, as illustrated, texture detection mechanism 110 may be hosted by memory 108 in communication with I/O source(s) 104, such as microphones, speakers, etc., of computing device 100. In another embodiment, texture detection mechanism 110 may be part of or hosted by operating system 106. In yet another embodiment, texture detection mechanism 110 may be hosted or facilitated by graphics driver 116. In yet another embodiment, texture detection mechanism 110 may be hosted by or part of graphics processing unit (“GPU” or simply graphics processor”) 114 or firmware of graphics processor 114. For example, texture detection mechanism 110 may be embedded in or implemented as part of the processing hardware of graphics processor 114. Similarly, in yet another embodiment, texture detection mechanism 110 may be hosted by or part of central processing unit (“CPU” or simply “application processor”) 112. For example, texture detection mechanism 110 may be embedded in or implemented as part of the processing hardware of application processor 112.

In yet another embodiment, texture detection mechanism 110 may be hosted by or part of any number and type of components of computing device 100, such as a portion of texture detection mechanism 110 may be hosted by or part of operating system 116, another portion may be hosted by or part of graphics processor 114, another portion may be hosted by or part of application processor 112, while one or more portions of texture detection mechanism 110 may be hosted by or part of operating system 116 and/or any number and type of devices of computing device 100. It is contemplated that embodiments are not limited to certain implementation or hosting of texture detection mechanism 110 and that one or more portions or components of texture detection mechanism 110 may be employed or implemented as hardware, software, or any combination thereof, such as firmware.

Computing device 100 may host network interface device(s) to provide access to a network, such as a LAN, a wide area network (WAN), a metropolitan area network (MAN), a personal area network (PAN), Bluetooth, a cloud network, a mobile network (e.g., 3^{rd} Generation (3G), 4^{th} Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

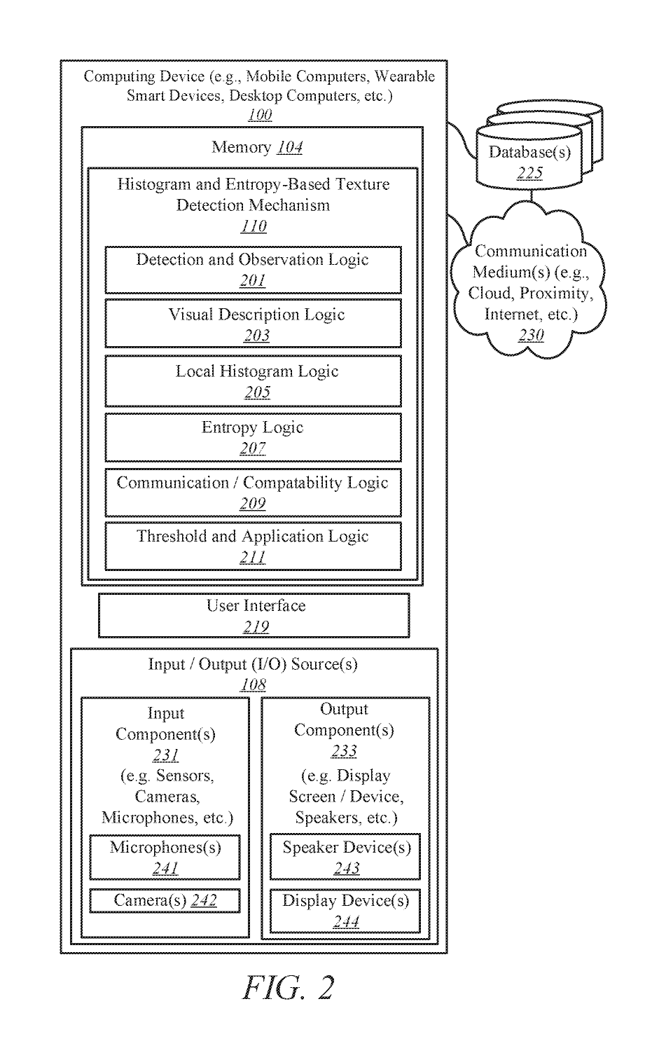

FIG. 2 illustrates histogram and entropy-based texture detection mechanism 110 of FIG. 1 according to one embodiment. For brevity, many of the details already discussed with reference to FIG. 1 are not repeated or discussed hereafter. In one embodiment, texture detection mechanism 110 may include any number and type of components, such as (without limitations): detection and observation logic 201; visual description logic 203; local histogram logic 205; entropy logic 207; communication/compatibility logic 209; and threshold and application logic 211.

Computing device 100 is further shown to include user interface 219 (e.g., graphical user interface (GUI)-based user interface, Web browser, cloud-based platform user interface, software application-based user interface, other user or application programming interfaces (APIs), etc.). Computing device 100 may further include I/O source(s) 108 having input component(s) 231, such as camera(s) 242 (e.g., Intel® RealSense™ camera), sensors, microphone(s) 241, etc., and output component(s) 233, such as display device(s) or simply display(s) 244 (e.g., integral displays, tensor displays, projection screens, display screens, etc.), speaker devices(s) or simply speaker(s), etc.

Computing device 100 is further illustrated as having access to and/or being in communication with one or more database(s) 225 and/or one or more of other computing devices over one or more communication medium(s) 230 (e.g., networks such as a proximity network, a cloud network, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O sources 108 including input component(s) 231 and output component(s) 233. In one embodiment, input component(s) 231 may include a sensor array including, but not limited to, microphone(s) 241 (e.g., ultrasound microphones), camera(s) 242 (e.g., two-dimensional (2D) cameras, three-dimensional (3D) cameras, infrared (IR) cameras, depth-sensing cameras, etc.), capacitors, radio components, radar components, scanners, and/or accelerometers, etc. Similarly, output component(s) 233 may include any number and type of display device(s) 244, projectors, light-emitting diodes (LEDs), speaker(s) 243, and/or vibration motors, etc.

As aforementioned, terms like “logic”, “module”, “component”, “engine”, “circuitry”, and “mechanism” may include, by way of example, software or hardware and/or a combination thereof, such as firmware. For example, logic may itself be or include or be associated with circuitry at one or more devices, such as application processor 112 and/or graphics processor 114 of FIG. 1, to facilitate or execute the corresponding logic to perform certain tasks, such as visual description circuitry may itself be or facilitate or execute visual description logic 203 to perform visual description-related operations (such as computing LBP).

For example, as illustrated, input component(s) 231 may include any number and type of microphones(s) 241, such as multiple microphones or a microphone array, such as ultrasound microphones, dynamic microphones, fiber optic microphones, laser microphones, etc. It is contemplated that one or more of microphone(s) 241 serve as one or more input devices for accepting or receiving audio inputs (such as human voice) into computing device 100 and converting this audio or sound into electrical signals. Similarly, it is contemplated that one or more of camera(s) 242 serve as one or more input devices for detecting and capturing of image and/or videos of scenes, objects, etc., and provide the captured data as video inputs into computing device 100.

It is contemplated that embodiments are not limited to any number or type of microphone(s) 241, camera(s) 243, speaker(s) 243, display(s) 244, etc. For example, as facilitated by detection and observation logic 201, one or more of microphone(s) 241 may be used to detect speech or sound simultaneously from users, such as speakers. Similarly, as facilitated by detection and observation logic 201, one or more of camera(s) 242 may be used to capture images or videos of a geographic location (whether that be indoors or outdoors) and its associated contents (e.g., furniture, electronic devices, humans, animals, trees, mountains, etc.) and form a set of images or a video stream.

Similarly, as illustrated, output component(s) 233 may include any number and type of speaker(s) or speaker device(s) 243 to serve as output devices for outputting or giving out audio from computing device 100 for any number or type of reasons, such as human hearing or consumption. For example, speaker(s) 243 work the opposite of microphone(s) 241 where speaker(s) 243 convert electric signals into sound.

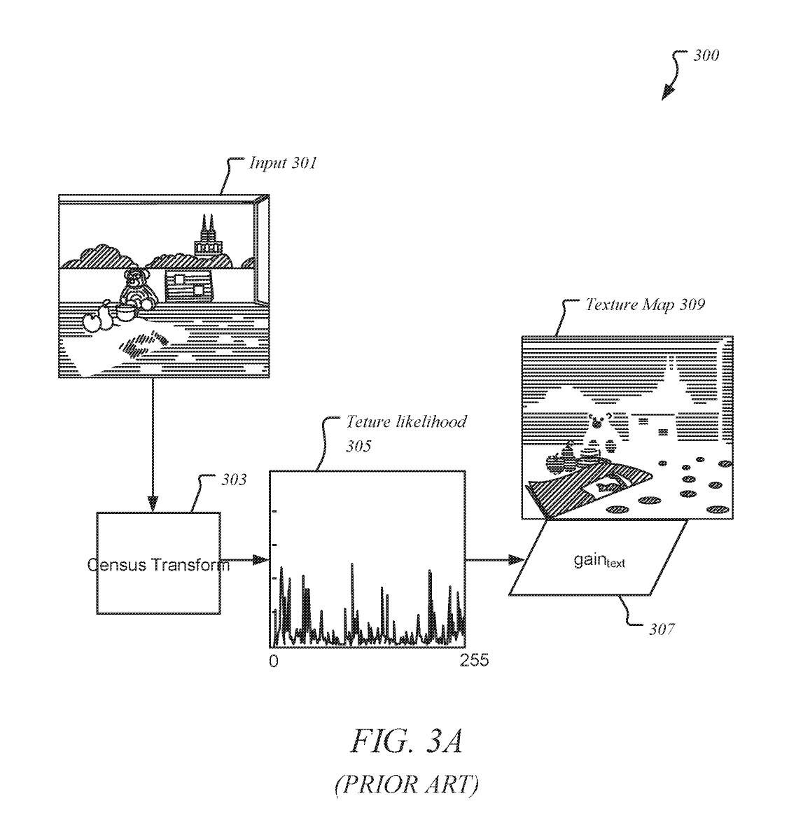

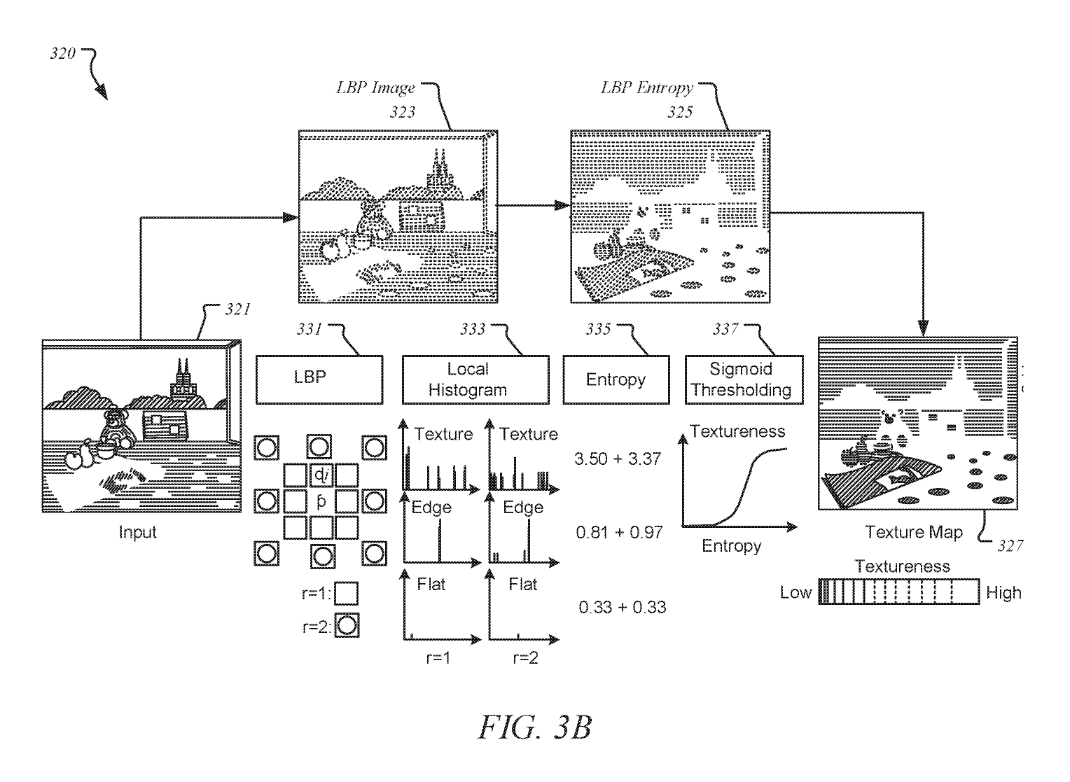

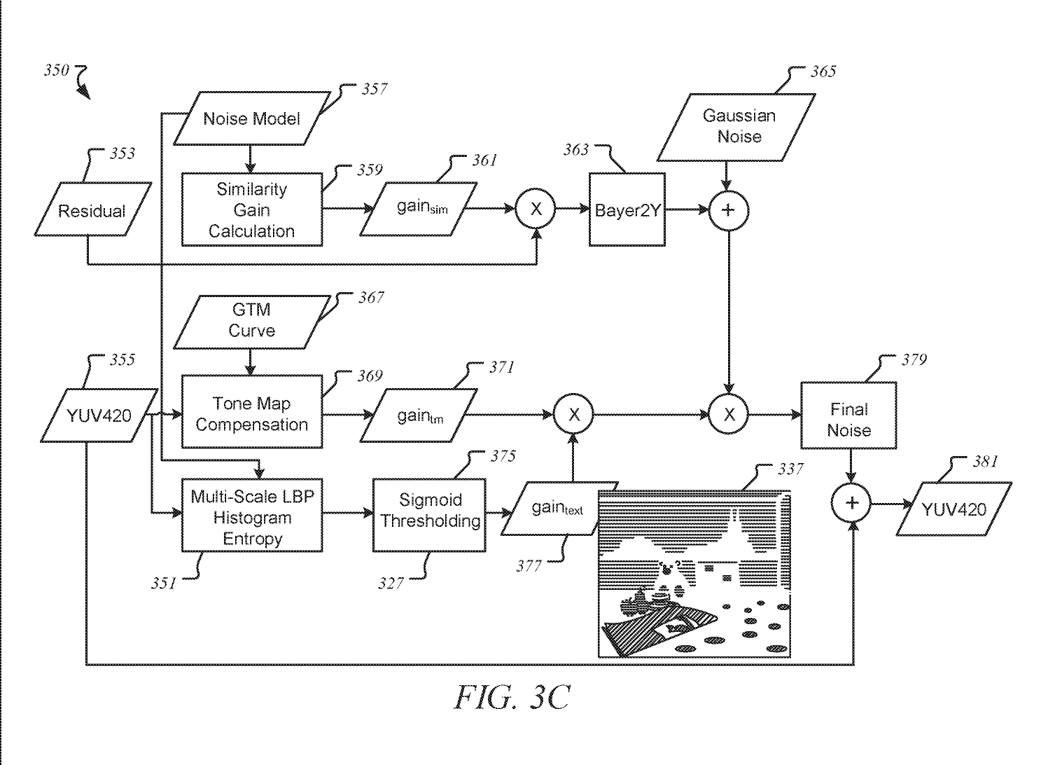

As discussed above, conventional techniques are limited in their applications and inefficient in their outcomes. For example, transaction sequence 300 of a conventional technique of census transform is illustrated in FIG. 3A, where input 301 is processed through census transform 303 to produce texture likelihood 305, which is then applied to obtain gain 307 and subsequently, texture map 309. This conventional census transform technique provides for adding back a noise reduction filter residual signal to the noise reduction filter output for detecting texture regions, but for such a technique, threshold δ for LBP calculation is not adaptive locally, although local pixel differences can depend on pixel intensity, various color channels (Gr, R, Gb, B in Bayer), at a radial distance from the optical center, etc. Further, for example, only look at a 3×3 local neighborhood, texture is a local group of edges, dots, blobs, etc., with various orientations, while the 3×3 region is too small to able to capture such structures. With such conventional technique, it is very difficult and inefficient to obtain any level of accuracy regard 256-bin lookup tables to represent textureness usable in any ISP blocks.

In imaging, a preservation of weak low contrast texture is a challenging task, such as regarding an ISP, various noise reduction and image enhancement blocks tend to degrade such weak textured regions, resulting in unnatural image. To preserve weak textures, embodiments provide for a novel technique for conducting a robust multi-scale LBP histogram entropy-based texture detection, as facilitated by texture detection mechanism 110.

For example, upon capturing and detecting scenes as facilitated by detection and observation logic 201, visual description logic 203 may be triggered to calculate one or more types of visual description, such as LBP, used in classification of computer vision. In one embodiment, noise model-based LBP may be calculated as LBP value=bin2dec(c₇c₆c₅c₄c₃c₂c₁c₀), where:

$${c}_{i} = \{ \begin{matrix}0 & {q}_{1} \leq p + 8 ( p ) \\ 1 & {q}_{i} > p + 8 ( p )\end{matrix}$$

Where p refers to central pixel, while q refers to surrounding pixels in a 3×3 local region, where δ(p) is calculated by α·NM(p), where NM(p) is noise model and a denotes tuning parameter. For example, if an input image is Bayer RAW, then NM(p) can be modeled as \sqrt{a·p+b} with calibration parameter a and b (here, for example, PRNU is assumed to be negligible for simplicity of notation). In case the input image is YUV, LBP is calculated on Y channel, where for Y channel, NM(p) can be modeled as g_{TM}·g(r)·a·(M⊙M)·WB·M⁻¹. YUV, where M denotes color correction matrix, g(r) denotes radial gain from lens shading correction, g_{TM} represents gain by tone mapping, and where WB denotes WB gain vector [w_{R}, w_{G}, w_{B}].

Embodiments provide for a novel technique for calculating multi-scale and noise model-based LBP and using the calculated LBP for rigorous training of texture likelihood in 256-bin look up tables, as illustrated with respect to FIG. 3B. As illustrated, FIG. 3B illustrates transaction sequence 320 for texture map calculation based on LBP histogram entropy according to one embodiment, where input image 321 (e.g., Bayer RAW input image) representing a scene that is captured using camera(s) 242 as facilitated by detection and observation logic 201, where scene is that of a physical area, such as a room, including objects, such as furniture, books, personal items, etc. In one embodiment, once input image 321 of the scene is captured and detected using detection and observation logic 201, visual description logic 203 is then triggered to calculate a type of visual description, such as multi-scale LBP of input image 321 to produce LBP image 323 associated with or based on LBP 331 and local histogram 333. In the illustrated embodiment, multi-scale LBP is used, in which each scale uses a different radius in LBP calculations as facilitated by visual description logic 203.

Further, in one embodiment, as illustrated in FIG. 3B, for each scale of LBP image 323, local histogram 333 (e.g., typical window size of 5×5) is calculated using local histogram logic 205. For example, as illustrated in FIG. 3B, local histogram 333 provides for histograms of texture, edge, flat regions, etc.

Upon calculating local histogram 333, as facilitated by local histogram logic 205, LBP entropy 325 is calculated using entropy logic 207, where LBP entropy 325 represents an aggregate of entropy 335 for all scales. In one embodiment, once all entropy 335 for all scales are calculated and aggregated to be represented as LBP entropy 325, as facilitated by entropy logic 207, a simple sigmoid threshold is determined and applied by threshold and application logic 211 to convert LBP entropy 325 to textureness values of texture map 327 within a certain range, such as range of [0.0, 1.0] for easy usage in an ISP block.

Referring now to FIG. 3C, it illustrates pipeline 350 for plugging in texture map into ISP in one embodiment. For example, as illustrated, multi-scale LBP histogram entropy 351, along with texture map 327 and sigmoid threshold 337, of FIG. 3B is inserted in pipeline 350, replacing any conventional techniques. As illustrated here and described with reference to FIG. 3B, multi-scale LBP histogram entropy 351 is calculated based on noise model 357, where residual input 353 and YUV420 input 355 are obtained and used for similarity gain calculation 359 and tone map compensation 369, respectively.

As further illustrated, similarity gain calculation 359 leads to gainₛᵢₘ 361 and Bayer2Y 365. Similarly, tone map compensation 369 takes an input of global tone mapping (GTM) curve 367, which leads to gainₜₘ 371 and then on to gainₜₑₓₜ 377, where Gaussian noise 365 is considered, leading to final noise 379 and YUV 420. Any final images obtained based on texture map 337 and final noise are displayed using display device(s) 244.

Referring to FIG. 2, input component(s) 231 may further include any number and type of cameras, such as depth-sensing cameras or capturing devices (e.g., Intel® RealSense™ depth-sensing camera) that are known for capturing still and/or video red-green-blue (RGB) and/or RGB-depth (RGB-D) images for media, such as personal media. Such images, having depth information, have been effectively used for various computer vision and computational photography effects, such as (without limitations) scene understanding, refocusing, composition, cinema-graphs, etc. Similarly, for example, displays may include any number and type of displays, such as integral displays, tensor displays, stereoscopic displays, etc., including (but not limited to) embedded or connected display screens, display devices, projectors, etc.

Input component(s) 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more input component(s) 231 may further include one or more of supporting or supplemental devices for capturing and/or sensing of data, such as illuminators (e.g., IR illuminator), light fixtures, generators, sound blockers, etc.

It is further contemplated that in one embodiment, input component(s) 231 may further include any number and type of context sensors (e.g., linear accelerometer) for sensing or detecting any number and type of contexts (e.g., estimating horizon, linear acceleration, etc., relating to a mobile computing device, etc.). For example, input component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, input component(s) 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Input component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 209 may be used to facilitate dynamic communication and compatibility between various components, networks, computing devices, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, “circuitry”, and/or the like, may be referenced interchangeably and include, by way of example, software, hardware, and/or any combination of software and hardware, such as firmware. In one example, “logic” may refer to or include a software component that works with one or more of an operating system, a graphics driver, etc., of a computing device, such as voice-enabled device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “noise model”, “local binary pattern”, “LBP”, “LBP image”, “local histogram”, “entropy”, “LBP entropy”, “sigmoid threshold”, “textureness”, “texture map”, “RealSense™ camera”, “real-time”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from texture detection mechanism 110 to facilitate various embodiments including adding, removing, and/or enhancing certain features. For brevity, clarity, and ease of understanding of texture detection mechanism 110, many of the standard and/or known components, such as those of a computing device, are not shown or discussed here. It is contemplated that embodiments, as described herein, are not limited to any technology, topology, system, architecture, and/or standard and are dynamic enough to adopt and adapt to any future changes.

As described with reference to FIG. 2, FIG. 3A illustrates a transactional sequence 300 of a conventional technique.

As described with reference to FIG. 2, FIG. 3B illustrates a transactional sequence 320 for texture map calculation based on LBP histogram entropy according to one embodiment.

As described with reference to FIG. 2, FIG. 3C illustrates a pipeline 350 incorporating a texture map 327 of FIG. 3B according to one embodiment.

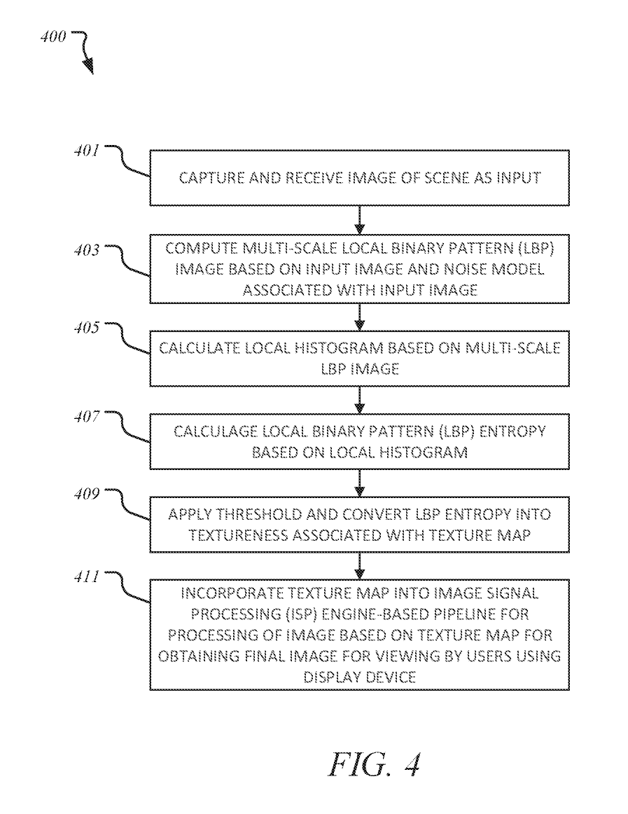

FIG. 4 illustrates a method for facilitating histogram entropy-based texture detection according to one embodiment. For brevity, many of the details previously discussed with reference to FIGS. 1-3C may not be discussed or repeated hereafter. Any processes or transactions may be performed by processing logic that may comprise hardware (e.g., circuitry, dedicated logic, programmable logic, etc.), software (such as instructions run on a processing device), or a combination thereof, as facilitated by texture detection mechanism 110 of FIG. 1. Any processes or transactions associated with this illustration may be illustrated or recited in linear sequences for brevity and clarity in presentation; however, it is contemplated that any number of them can be performed in parallel, asynchronously, or in different orders.

Method 400 begins at block 401 with capturing of an image of a scene and receiving of the image as an input (e.g., Bayer, Y, etc.), where the image is captured by one or more cameras associated with a computing device. At block 403, multi-scale and noise model-based LBP is calculated to obtain an LBP image based on the input image, where the multi-scale LBP is used such that each scale uses a different radius in LBP calculation. At block 405, for each scale of LBP image, a local histogram (e.g., typical window size of 5×5) is calculated, including histograms for textures, edges, flat regions, etc. At block 407, on local histogram, for each of the scales, entropy is calculated and aggregated into LBP entropy. At block 409, a simple threshold (e.g., sigmoid threshold) is applied to convert LBP entropy into textureness values (e.g., ranging from 0.0 to 1.0) associated with a texture map for easy usage in an ISP engine. At block 411, incorporate the texture map into the ISP engine-based pipeline for obtaining a final output of the input image based on the texture map to be viewed by an end-user using one or more display screens of the computing device or any other computing devices.

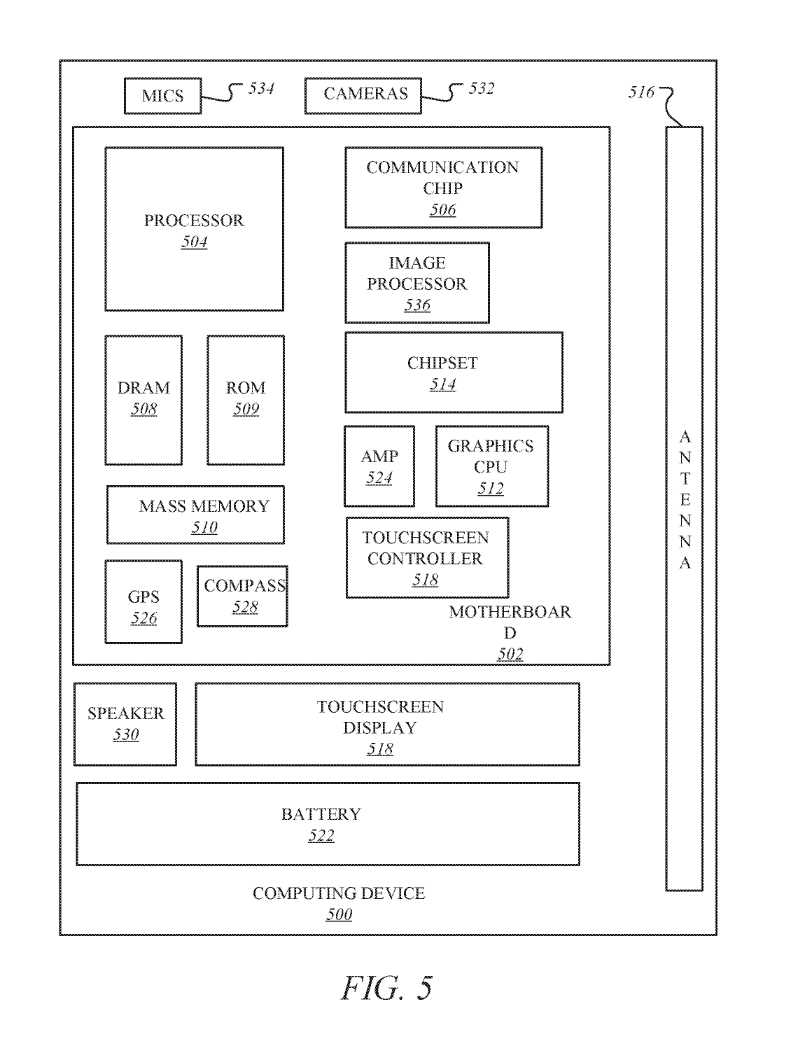

FIG. 5 illustrates a computing device 500 in accordance with one implementation. The illustrated computing device 500 may be same as or similar to computing device 100 of FIG. 1. The computing device 500 houses a system board 502. The board 502 may include a number of components, including but not limited to a processor 504 and at least one communication package 506. The communication package is coupled to one or more antennas 516. The processor 504 is physically and electrically coupled to the board 502.

Depending on its applications, computing device 500 may include other components that may or may not be physically and electrically coupled to the board 502. These other components include, but are not limited to, volatile memory (e.g., DRAM) 508, non-volatile memory (e.g., ROM) 509, flash memory (not shown), a graphics processor 512, a digital signal processor (not shown), a crypto processor (not shown), a chipset 514, an antenna 516, a display 518 such as a touchscreen display, a touchscreen controller 520, a battery 522, an audio codec (not shown), a video codec (not shown), a power amplifier 524, a global positioning system (GPS) device 526, a compass 528, an accelerometer (not shown), a gyroscope (not shown), a speaker 530, cameras 532, a microphone array 534, and a mass storage device (such as hard disk drive) 510, compact disk (CD) (not shown), digital versatile disk (DVD) (not shown), and so forth). These components may be connected to the system board 502, mounted to the system board, or combined with any of the other components.

The communication package 506 enables wireless and/or wired communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 506 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 500 may include a plurality of communication packages 506. For instance, a first communication package 506 may be dedicated to shorter range wireless communications such as Wi-Fi and Bluetooth and a second communication package 506 may be dedicated to longer range wireless communications such as GPS, EDGE, GPRS, CDMA, WiMAX, LTE, Ev-DO, and others.

The cameras 532 including any depth sensors or proximity sensor are coupled to an optional image processor 536 to perform conversions, analysis, noise reduction, comparisons, depth or distance analysis, image understanding, and other processes as described herein. The processor 504 is coupled to the image processor to drive the process with interrupts, set parameters, and control operations of image processor and the cameras. Image processing may instead be performed in the processor 504, the graphics CPU 512, the cameras 532, or in any other device.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 500 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

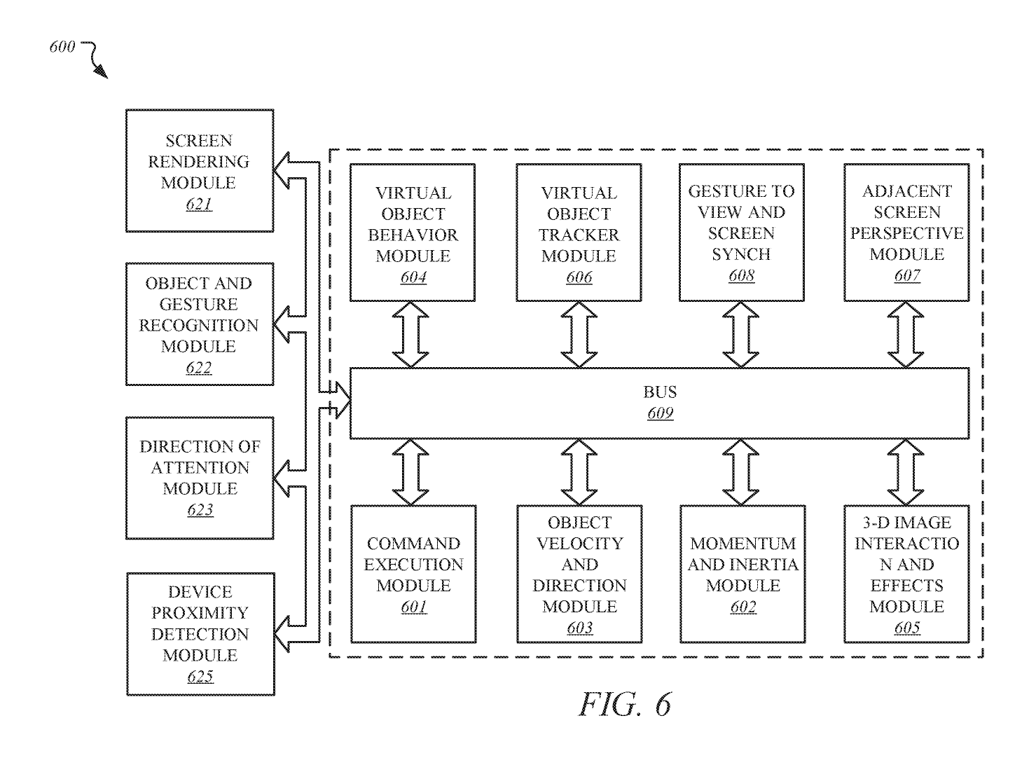

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition Module 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition Module 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition Module 622. Various views of an application on one or more screens can be associated with alternative gesture libraries or a set of gesture templates for a given view. As an example, in FIG. 1A, a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual objects across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition Module 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes an apparatus to facilitate histogram and entropy-based texture detection, the apparatus comprising: a processor coupled with memory hosting a mechanism, wherein the processor to execute: detection and observation logic to detect an image of a scene; visual description logic to compute multi-scale local binary pattern (LBP) image for the detected image based on a noise model associated with the detected image; local histogram logic to calculate a local histogram based the multi-scale LBP image; entropy logic to calculate LBP entropy based on the local histogram; and threshold and application logic to apply a threshold to convert the LBP entropy into textureness of a texture map of the detected image for processing by an image signal processing (ISP) engine.

Example 2 includes the subject matter of Example 1, wherein the detected image comprises one or more of a Bayer image and a Y image, wherein multiple scales of the multi-scale LBP image use multiple radiuses in LBP computation.

Example 3 includes the subject matter of Examples 1-2, wherein the local histogram is calculated for each scale of the multiple scales of the multi-scale LBP image, wherein the local histogram represents one or more of textures, edges, and flat regions associated with the detected image.

Example 4 includes the subject matter of Examples 1-3, wherein the processor is further to execute the entropy logic to calculate multiple entropies corresponding to the multiple scales, wherein the LBP entropy represents an aggregation of the multiple entropies.

Example 5 includes the subject matter of Examples 1-4, wherein the threshold is based on one or more machine learning functions, wherein the threshold includes a sigmoid threshold based on a sigmoid function of the machine learning functions.

Example 6 includes the subject matter of Examples 1-5, wherein the texture map is placed in a pipeline associated with the ISP engine for preservation of the textureness, wherein the pipeline includes multiple value and computation inputs including one or more of the noise model, a Gaussian noise, a global tone mapping (GTM) curve, a final noise, and a similarity gain calculation value.

Example 7 includes the subject matter of Examples 1-6, wherein the processor comprises one or more of a graphics processor and an application processor, wherein the graphics processor and the application processor are co-located on a common semiconductor package.

Some embodiments pertain to Example 8 that includes a method facilitating histogram and entropy-based texture detection in computing systems, the method comprising: detecting an image of a scene; computing multi-scale local binary pattern (LBP) image for the detected image based on a noise model associated with the detected image; calculating a local histogram based the multi-scale LBP image; calculating LBP entropy based on the local histogram; and applying a threshold to convert the LBP entropy into textureness of a texture map of the detected image for processing by an image signal processing (ISP) engine.

Example 9 includes the subject matter of Example 8, wherein the detected image comprises one or more of a Bayer image and a Y image, wherein multiple scales of the multi-scale LBP image use multiple radiuses in LBP computation.

Example 10 includes the subject matter of Examples 8-9, wherein the local histogram is calculated for each scale of the multiple scales of the multi-scale LBP image, wherein the local histogram represents one or more of textures, edges, and flat regions associated with the detected image.

Example 11 includes the subject matter of Examples 8-10, further comprising calculating multiple entropies corresponding to the multiple scales, wherein the LBP entropy represents an aggregation of the multiple entropies.

Example 12 includes the subject matter of Examples 8-11, wherein the threshold is based on one or more machine learning functions, wherein the threshold includes a sigmoid threshold based on a sigmoid function of the machine learning functions.

Example 13 includes the subject matter of Examples 8-12, wherein the texture map is placed in a pipeline associated with the ISP engine for preservation of the textureness, wherein the pipeline includes multiple value and computation inputs including one or more of the noise model, a Gaussian noise, a global tone mapping (GTM) curve, a final noise, and a similarity gain calculation value.

Example 14 includes the subject matter of Examples 8-13, wherein the method is executed by a processor comprising one or more of a graphics processor and an application processor, wherein the graphics processor and the application processor are co-located on a common semiconductor package of a computing device.

Some embodiments pertain to Example 15 that includes a data processing system comprising a computing device having a memory device coupled to a processing device, the processing device to perform operations comprising: detecting an image of a scene; computing multi-scale local binary pattern (LBP) image for the detected image based on a noise model associated with the detected image; calculating a local histogram based the multi-scale LBP image; calculating LBP entropy based on the local histogram; and applying a threshold to convert the LBP entropy into textureness of a texture map of the detected image for processing by an image signal processing (ISP) engine.

Example 16 includes the subject matter of Example 15, wherein the detected image comprises one or more of a Bayer image and a Y image, wherein multiple scales of the multi-scale LBP image use multiple radiuses in LBP computation.

Example 17 includes the subject matter of Example 15-16, wherein the local histogram is calculated for each scale of the multiple scales of the multi-scale LBP image, wherein the local histogram represents one or more of textures, edges, and flat regions associated with the detected image.

Example 18 includes the subject matter of Example 15-17, further comprising calculating multiple entropies corresponding to the multiple scales, wherein the LBP entropy represents an aggregation of the multiple entropies.

Example 19 includes the subject matter of Example 15-18, wherein the threshold is based on one or more machine learning functions, wherein the threshold includes a sigmoid threshold based on a sigmoid function of the machine learning functions.

Example 20 includes the subject matter of Example 15-19, wherein the texture map is placed in a pipeline associated with the ISP engine for preservation of the textureness, wherein the pipeline includes multiple value and computation inputs including one or more of the noise model, a Gaussian noise, a global tone mapping (GTM) curve, a final noise, and a similarity gain calculation value.

Example 21 includes the subject matter of Example 15-20, wherein the method is executed by a processor comprising one or more of a graphics processor and an application processor, wherein the graphics processor and the application processor are co-located on a common semiconductor package of a computing device.

Example 22 includes at least one non-transitory or tangible machine-readable medium comprising a plurality of instructions, when executed on a computing device, to implement or perform a method as claimed in any of claims or examples 8-14.

Example 23 includes at least one machine-readable medium comprising a plurality of instructions, when executed on a computing device, to implement or perform a method as claimed in any of claims or examples 8-14.

Example 24 includes a system comprising a mechanism to implement or perform a method as claimed in any of claims or examples 8-14.

Example 25 includes an apparatus comprising means for performing a method as claimed in any of claims or examples 8-14.

Example 26 includes a computing device arranged to implement or perform a method as claimed in any of claims or examples 8-14.

Example 27 includes a communications device arranged to implement or perform a method as claimed in any of claims or examples 8-14.

Example 28 includes at least one machine-readable medium comprising a plurality of instructions, when executed on a computing device, to implement or perform a method or realize an apparatus as claimed in any preceding claims.

Example 29 includes at least one non-transitory or tangible machine-readable medium comprising a plurality of instructions, when executed on a computing device, to implement or perform a method or realize an apparatus as claimed in any preceding claims.

Example 30 includes a system comprising a mechanism to implement or perform a method or realize an apparatus as claimed in any preceding claims.

Example 31 includes an apparatus comprising means to perform a method as claimed in any preceding claims.

Example 32 includes a computing device arranged to implement or perform a method or realize an apparatus as claimed in any preceding claims.

Example 33 includes a communications device arranged to implement or perform a method or realize an apparatus as claimed in any preceding claims.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
a processor coupled with memory hosting a mechanism, wherein the processor to execute:
detection and observation logic to detect an image of a scene;
visual description logic to compute multi-scale local binary pattern (LBP) image for the detected image based on a noise model associated with the detected image;
local histogram logic to calculate a local histogram based the multi-scale LBP image;
entropy logic to calculate LBP entropy based on the local histogram; and
threshold and application logic to apply a threshold to convert the LBP entropy into textureness of a texture map of the detected image for processing by an image signal processing (ISP) engine.

2. The apparatus of claim 1, wherein the detected image comprises one or more of a Bayer image and a Y image, wherein multiple scales of the multi-scale LBP image use multiple radiuses in LBP computation.

3. The apparatus of claim 1, wherein the local histogram is calculated for each scale of the multiple scales of the multi-scale LBP image, wherein the local histogram represents one or more of textures, edges, and flat regions associated with the detected image.

4. The apparatus of claim 1, wherein the processor is further to execute the entropy logic to calculate multiple entropies corresponding to the multiple scales, wherein the LBP entropy represents an aggregation of the multiple entropies.

5. The apparatus of claim 1, wherein the threshold is based on one or more machine learning functions, wherein the threshold includes a sigmoid threshold based on a sigmoid function of the machine learning functions.

6. The apparatus of claim 1, wherein the texture map is placed in a pipeline associated with the ISP engine for preservation of the textureness, wherein the pipeline includes multiple value and computation inputs including one or more of the noise model, a Gaussian noise, a global tone mapping (GTM) curve, a final noise, and a similarity gain calculation value.

7. The apparatus of claim 1, wherein the processor comprises one or more of a graphics processor and an application processor, wherein the graphics processor and the application processor are co-located on a common semiconductor package.

8. A method comprising:
detecting an image of a scene;
computing multi-scale local binary pattern (LBP) image for the detected image based on a noise model associated with the detected image;
calculating a local histogram based the multi-scale LBP image;
calculating LBP entropy based on the local histogram; and
applying a threshold to convert the LBP entropy into textureness of a texture map of the detected image for processing by an image signal processing (ISP) engine.

9. The method of claim 8, wherein the detected image comprises one or more of a Bayer image and a Y image, wherein multiple scales of the multi-scale LBP image use multiple radiuses in LBP computation.

10. The method of claim 8, wherein the local histogram is calculated for each scale of the multiple scales of the multi-scale LBP image, wherein the local histogram represents one or more of textures, edges, and flat regions associated with the detected image.

11. The method of claim 8, further comprising calculating multiple entropies corresponding to the multiple scales, wherein the LBP entropy represents an aggregation of the multiple entropies.

12. The method of claim 8, wherein the threshold is based on one or more machine learning functions, wherein the threshold includes a sigmoid threshold based on a sigmoid function of the machine learning functions.

13. The method of claim 8, wherein the texture map is placed in a pipeline associated with the ISP engine for preservation of the textureness, wherein the pipeline includes multiple value and computation inputs including one or more of the noise model, a Gaussian noise, a global tone mapping (GTM) curve, a final noise, and a similarity gain calculation value.

14. The method of claim 8, wherein the method is executed by a processor comprising one or more of a graphics processor and an application processor, wherein the graphics processor and the application processor are co-located on a common semiconductor package of a computing device.

15. At least one machine-readable medium comprising instructions which, when executed by a computing device, cause the computing device to perform operations comprising:
detecting an image of a scene;
computing multi-scale local binary pattern (LBP) image for the detected image based on a noise model associated with the detected image;
calculating a local histogram based the multi-scale LBP image;
calculating LBP entropy based on the local histogram; and
applying a threshold to convert the LBP entropy into textureness of a texture map of the detected image for processing by an image signal processing (ISP) engine.

16. The machine-readable medium of claim 15, wherein the detected image comprises one or more of a Bayer image and a Y image, wherein multiple scales of the multi-scale LBP image use multiple radiuses in LBP computation.

17. The machine-readable medium of claim 15, wherein the local histogram is calculated for each scale of the multiple scales of the multi-scale LBP image, wherein the local histogram represents one or more of textures, edges, and flat regions associated with the detected image.

18. The machine-readable medium of claim 15, further comprising calculating multiple entropies corresponding to the multiple scales, wherein the LBP entropy represents an aggregation of the multiple entropies.

19. The machine-readable medium of claim 15, wherein the threshold is based on one or more machine learning functions, wherein the threshold includes a sigmoid threshold based on a sigmoid function of the machine learning functions.

20. The machine-readable medium of claim 15, wherein the texture map is placed in a pipeline associated with the ISP engine for preservation of the textureness, wherein the pipeline includes multiple value and computation inputs including one or more of the noise model, a Gaussian noise, a global tone mapping (GTM) curve, a final noise, and a similarity gain calculation value,
wherein the operations are executed by a processor comprising one or more of a graphics processor and an application processor, wherein the graphics processor and the application processor are co-located on a common semiconductor package of the computing device.
